(19) United States
(12) Patent Application Publication
(10) Pub. No.: US 2008/0165008 A1
(43) Pub. Date: Jul. 10, 2008

(54) METHOD AND APPARATUS TO CONTROL OFFSITE ALCOHOL CONSUMPTION AND GLASSWARE LOSS IN A TAVERN ENVIRONMENT AND ASSOCIATED METHOD AND APPARATUS FOR TAVERN MANAGEMENT

(76) Inventor: David Mercier, Fayetteville, WV (US)

Correspondence Address: BLYNN L. SHIDELER;THE BLK LAW GROUP, 3500 BROKKTREE ROAD, SUITE 200, WEXFORD, PA, 15090, US

(21) Appl. No.: 11/969,643

(22) Filed: Jan. 4, 2008

Related U.S. Application Data
(60) Provisional application No. 60/883,815, filed on Jan. 7, 2007.

(51) Int. Cl. G08B 13/14

(52) U.S. Cl. 340/572.1

(57) ABSTRACT

An integrated glassware control system for a tavern environment comprises (a) a plurality of glassware drinking vessels; (b) an electronic article surveillance tag, such as a passive or semi-active or active tag, coupled to each glassware drinking vessel; and (c) at least one tag recognition gate at a tavern exit, each gate having an associated alarm that is activated upon detection of an unauthorized tag.

### CROSS-REFERENCE TO RELATED APPLICATION

This application claims the benefit of U.S. Provisional Patent Application Ser. No. 60/883,815, entitled “Glassware with Integrated Mechanism for Loss Prevention and Liability Protection”, filed on Jan. 7, 2007.

### BACKGROUND OF THE INVENTION

1. Field of the Invention

The present invention relates generally to a method for minimizing and preventing offsite alcohol consumption and glassware loss through a glassware tracking and/or control system and an associated method and apparatus of tavern management. More specifically, the present invention is directed to glassware with an integrated mechanism for loss prevention and liability protection and use of such system in tavern management.

2. Description of Related Art

Glassware Background:

Glassware is the collection of drinking vessels formed from glass. In this application “glassware” and “glasses” will define drinking vessels generally, but not necessarily, formed from glass. Plastic versions and ceramic versions (e.g. coffee mugs) will fall into the definition of glassware and glasses within this application and a specific reference to the glass forming material will be used if a narrower definition is intended (e.g. “glassware formed from glass”). The thermal and other properties associated with glass give it some consumer preference over other non glass material drinking vessels. In other words a glass formed beer mug will generally have more consumer preference than a plastic beer glass (although portability and disposability and costs give plastic certain advantages in certain applications such as an outdoor picnic). Most commercial establishments utilize glass (and ceramic) glassware in light of such customer preferences.

There are various types of glassware of different shapes and sizes, all serving their own purpose. Learning which drinks belong to which glass is beneficial to both the individual bartender and the establishment's customers. Within this application a commercial establishment can be interchangeable referenced as taverns, inns, bars, restaurants, diners, clubs, and the like. The possible differences between these establishment types are immaterial with regard to this application as they all face similar glassware control issues as described herein. The customers receive a higher quality drink when served in the appropriate container, which in turn reflects positively back on the establishment. For example there are (a) Beer mugs: The traditional beer container, typical Size: 16 oz.; (b) Brandy snifters: The shape of this glass concentrates the alcoholic odors to the top of the glass as your hands warm the brandy, typical Size: 17.5 oz.; (c) Champagne flutes: This tulip shaped glass is designed to show off the waltzing bubbles of the wine as they brush against the side of the glass and spread out into a sparkling mousse, typical Size: 6 oz.; (d) Cocktail glasses: This glass has a triangle-bowl design with a long stem, and is used for a wide range of straight-up (without ice) cocktails, including martinis, manhattans, metropolitans, and gimlets, it is also known as a martini glass, typical Size: 4-12 oz.; (e) Coffee mugs: The traditional mug used for hot coffee (often a ceramic drinking vessel), typical Size: 12-16 oz.; (f) Collins glasses: Shaped similarly to a highball glass, only taller, the Collins glass was originally used for the line of Collins gin drinks, and is now also commonly used for soft drinks, alcoholic juice, and tropical/exotic juices such as Mai Tai's, typical Size: 14 oz.; (g) Cordial glasses: Small and stemmed glasses used for serving small portions of your favorite liquors at times such as after a meal, typical Size: 2 oz.; (h) Highball glasses: A straight-sided glass, often an elegant way to serve many types of mixed drinks, like those served on the rocks, shots, and mixer combined liquor drinks (i.e. gin and tonic), typical Size: 8-12 oz.; (i) Hurricane glasses: A tall, elegantly cut glass named after it's hurricane-lamp-like shape, used for exotic/tropical drinks, typical Size: 15 oz.; (j) Margarita/coupette glasses: This slightly larger and rounded approach to a cocktail glass has a broad-rim for holding salt, ideal for margarita's, and It is also used in daiquiris and other fruit drinks, typical Size: 12 oz.; (k) Mason jars: These large square containers are effective in keeping their contents sealed in an air tight environment, and are designed for home canning, being used for preserves and jam amongst other things, and have been used as a “novelty” serving container for certain establishments, typical Size: 16 oz.; (l) Old-fashioned glasses: A short, round so called “rocks” glass, suitable for cocktails or liquor served on the rocks, or “with a splash”, typical Size: 8-10 oz.; (m) Parfait glasses: This glass has a similar inwards curve to that of a hurricane glass, with a steeper outwards rim and larger, rounded bowl, and is often used for drinks containing fruit or ice cream, typical Size: 12 oz.; (n) Pousse-cafe glasses: A narrow glass essentially used for pousse café and other layered dessert drinks, wherein it's shape increases the ease of layering ingredients, typical Size: 6 oz.; (o) Punch bowls: A large demi-spherical bowl suitable for punches or large mixes, typical Size: 1-5 gal.; (p) Red wine glasses: A clear, thin, stemmed glass with a round bowl tapering inward at the rim, typical Size: 8 oz.; (p) Sherry glasses: The preferred glass for aperitifs, ports, and sherry, and the copita, with it's aroma enhancing narrow taper, is a type of sherry glass, typical Size: 2 oz.; (q) Shot glasses: A small glass suitable for vodka, whiskey and other liquors, and many “shot” mixed drinks also call for shot glasses, typical Size: 1.5 oz.; (r) Whiskey sour glasses: Also known as a delmonico glass, this is a stemmed, wide opening glass, alike to a small version of a champagne flute, typical Size: 5 oz.; (s) White wine glasses: A clear, thin, stemmed glass with an elongated oval bowl tapering inward at the rim, typical Size: 12.5 oz. This listing is not exhaustive but does cover a large majority of glasses that would be encountered in most establishments, and in fact most establishments may not carry all of the above described types.

It is recommended that an establishment ensure all glassware is cleaned spotless prior to serving it to your customers. It is recommended that all glassware be washed with hot water and a small amount of detergent (not soap) before use, followed by rinsing with fresh cold water and polishing them with a suitable cloth. It is further recommended to hold glasses by the base or stem of the glass to avoid fingerprints. As can be gleaned from the above discussion there is a significant emphasis placed upon the appearance of the glassware when presented to the customer.

Tavern owners must replace glassware at periodic intervals. The replacement requirement is driven by two factors. The first factor is glassware loss due to breakage. Breakage of glassware is a fact of tavern management. It is less common for some types of glasses (e.g. Beer mugs and shot glasses) than for others (stemmed glassware). Plastic glassware can be selected to minimize breakage concerns, but plastic is not always preferred by customers. Disposable plastic containers also avoid the cost of washing the containers after use, but again cost effective disposable plastic containers are not a customer preference in many establishments.

The second factor driving replacement of glassware by tavern owners is the loss of the glassware through customer action. Customers will both inadvertently and intentionally take glassware out of the establishment. Whether absentminded or purposeful on the customer's part, in such customer driven glassware removal, the glassware is still lost to the establishment and must be replaced. This customer loss of glassware is not an insignificant cost. One vendor selling disposable “bomb” glasses (i.e. a shot of one drink intended to be dropped in another drink, such as a shot in a beer) estimates that for 500 “bombs” sold by an establishment 10 glasses will be lost due to customer action (stolen) for a cost of over $22.00 (see www disposabomb.com). These estimates can vary depending on the particular clientele of a particular establishment (e.g. a college town tavern catering to a younger crowd may experience a relatively “high” glassware loss rate), however such loss is clearly a significant concern. It has been reported that some establishments have stopped ordering selected glassware in light of the customer removal problem associated with these glasses. This solution is limiting on the tavern and the patrons.

The customer's tendency to “walk off” with glassware raises a separate liability concern for the establishment. In many locations the establishment is legally responsible to maintain the drinking of alcoholic beverages within the premises. Establishments can incur significant legal fines and other more draconian penalties (e.g. revocation of a license to operate) for customer's drinking “off premises”. Consequently any system that minimizes, or hopefully eliminates, the customers walking off premises with the glassware will also be useful to minimize legal liabilities for the establishment, as it will naturally reduce customer “off premises” drinking.

It is the belief of the inventor that customer associated loss of glassware can be significantly reduced through an effective glassware tracking and/or control system such as in the present invention. As noted above the present invention relates to a glassware tracking and/or control system. It should be noted that the inventors are not aware of any actual existing glassware tracking and/or control system for use in a tavern type environment. As described below, the present invention utilizes existing inventory tracking technologies, particularly systems used by retailers for loss prevention, such as Radio Frequency Identification tags.

Loss Prevention Systems:

There's a lot of methods retailers use for loss prevention. A very popular method is to use a system that attaches special tags onto everything so that an alarm goes off whenever a shoplifter tries to walk out with an item. These tag and alarm systems, better known as electronic article surveillance (EAS) systems, identify articles as they pass through a gated area in a store. This identification is used to alert someone that unauthorized removal of items is being attempted. Using an EAS system enables the retailer to display popular items on the floor, where they can be seen, rather than putting them in locked cases or behind the counter. As discussed below EAS tags include but are not limited to passive, active and semi-active tags of RFID types, electro-magnetic and acoustic-magnetic types. Within the meaning of this application any tag that can be identified within a field or gate can be considered an electronic surveillance tag.

The type of EAS system dictates how wide the exit/entrance aisle may be, and the physics of a particular EAS tag and technology determines which frequency range is used to create a surveillance area. EAS systems range from very low frequencies through the radio frequency range. These EAS systems operate on different principles, are not compatible and have specific benefits and disadvantages.

Radio Frequency Identification (RFID) is an automatic identification method, relying on storing and remotely retrieving data using devices called RFID tags or transponders. The RFID technology is the most widely implemented EAS tag system that is implemented for retail loss prevention. An RFID tag is an object that can be attached to or incorporated into a product, (or an animal, or even a person) for the purpose of identification using radio waves. Chip-based RFID tags contain silicon chips and antennas. Passive tags require no internal power source, whereas active tags require a power source.

In 1946 Leon Theremin invented an espionage tool for the Soviet government which retransmitted incident radio waves with audio information. Sound-waves vibrated a diaphragm which slightly altered the shape of the resonator, which modulated the reflected radio frequency. Even though this device was a passive covert listening device, not an identification tag, it has been attributed as the first known device and a predecessor to RFID technology. The technology used in RFID has been around since the early 1920's according to one source (although the same source states that RFID systems have been around just since the late 1960's).

A more similar technology, the IFF transponder, was invented by the British in 1939, and was routinely used by the allies in World War II to identify airplanes as friend or foe. Transponders are still used by military and commercial aircraft to this day.

Another early work exploring RFID is the landmark 1948 paper by Harry Stockman, titled “Communication by Means of Reflected Power” (Proceedings of the IRE, pp 1196-1204, October 1948). Stockman predicted that “ . . . considerable research and development work has to be done before the remaining basic problems in reflected-power communication are solved, and before the field of useful applications is explored.” Mario Cardullo's U.S. Pat. No. 3,713,148 in 1973 was the first true ancestor of modern RFID; a passive radio transponder with memory. The initial reflective power passive device was demonstrated in 1971 to the New York Port Authority and other potential users and consisted of a transponder with 16 bit memory for use as a toll device. The basic Cardullo patent covers the use of RF, sound and light as transmission medium. The original business plan presented to investors in 1969 showed uses in transportation (automotive vehicle identification, automatic toll system, electronic license plate, electronic manifest, vehicle routing, vehicle performance monitoring), banking (electronic check book, electronic credit card), security (personnel identification, automatic gates, surveillance) and medical (identification, patient history). A demonstration of reflected power (backscatter) RFID tags, both passive and active, was done at the Los Alamos Scientific Laboratory in 1973.

The first patent to be associated with the acronym RFID was granted to Charles Walton in 1983 (U.S. Pat. No. 4,384,288). RFID cards are also known as “proximity”, “proxy” or “contact-less cards” and come in three general varieties: passive, semi-passive (also known as semi-active), or active. The present application is primarily concerned with passive tags as the most cost effective for the designated purpose, but active and semi-active tags would also function effectively.

Passive RFID tags have no internal power supply. The minute electrical current induced in the antenna by the incoming radio frequency signal provides just enough power for the CMOS integrated circuit in the tag to power up and transmit a response. Most passive tags signal by backscattering the carrier signal from the reader. This means that the antenna has to be designed to both collect power from the incoming signal and also to transmit the outbound backscatter signal. The response of a passive RFID tag is not necessarily just an ID number; the tag chip can contain non-volatile EEPROM for storing data.

The lack of an onboard power supply means that the device can be quite small: commercially available products exist that can be embedded in a sticker, or under the skin in the case of low frequency RFID tags. As of 2006 Hitachi, Ltd. has developed the smallest such passive devices called μ-Chip measuring 0.15×0.15 mm, and thinner than a sheet of paper (7.5 micrometers). Silicon-on-Insulator (SOI) technology is used to achieve this level of integration. The Hitachi μ-Chip can wirelessly transmit a 128 bit (10̂38) unique ID number which is hard coded into the chip as part of the manufacturing process. The unique ID in the chip cannot be altered, providing a high level of authenticity to the chip. The Hitachi μ-Chip has a typical read range maximum of 30 cm (1 foot) or less.

The lowest cost EPC RFID tags, which are the standard chosen by Wal-Mart, DoD, Target, Tesco in the UK and Metro AG in Germany, are available today at a price of around $0.05 each. The addition of the antenna creates a tag that varies from the size of a postage stamp to the size of a post card. Passive tags have practical read distances ranging from about 10 cm (4 in.) (see ISO 14443) up to a few meters (EPC and ISO 18000-6) depending on the chosen radio frequency and antenna design/size.

In 2002, X-ident developed a new washable RFID tag especially for application in the area of rented linen that has the ability to withstand washing temperatures (temperature range of tag: −20° C. to +95° C.). Dubbed the Laundry Tag, the printable, flexible X-ident RFID tag has a diameter of approximately 30 millimeters and may be glued or sewn into the seams of garments and other types of linen. Other companies have also developed the “washable” tag for incorporation directly into clothing. The applicant believes it is the temperature range that is significant for the purposes of the present invention as will be described below.

The Electromagnetic (EM) systems are a second type of EAS tag system and are described as being dominant in Europe. The EM systems are used by many retail chain stores, supermarkets and libraries around the world. In this technology, a magnetic, iron-containing strip with an adhesive layer is attached to the merchandise. This strip is not removed at checkout—it's simply deactivated by a scanner that uses a specific highly intense magnetic field. One of the advantages of the EM strip is that it can be reactivated and used at a low cost. What most people refer to as an electromagnetic tag is actually a metal wire or ribbon that has high permeability, making it easy for magnetic signals to flow through it. A magnetized piece of semi-hard magnetic material (basically, a weak magnet) is put up next to the active material to deactivate it. When you magnetize the semi-hard material, it saturates the tag and puts it in its inactive saturated state.

The EM system works by applying intensive low frequency magnetic fields generated by the transmitter antenna. When the strip passes through the gate, it will transmit a unique frequency pattern. This pattern is, in turn, being picked up by an adjacent receiver antenna. The small signal is processed and will trigger the alarm when the specific pattern is recognized. Because of the weak response of the strip, the low frequency (typically between 70 Hz and 1 kHz) and intensive field required by the EM system, EM antennas are larger than those used by most other EAS systems. The maximum distance between entry pedestals is 40 inches. Also, because of the low frequency here, the strips can be directly attached to metal surfaces. That's why EM systems are popular with hardware, book and record stores

Another magnetic technology used as an EAS system is the acousto-magnetic system, which has the ability to protect wide exits and allows for high-speed label application. It uses a transmitter to create a surveillance area where tags and labels are detected. The transmitter sends a radio frequency signal (of about 58 kHz) in pulses, which energize a tag in the surveillance zone. When the pulse ends, the tag responds, emitting a single frequency signal like a tuning fork. While the transmitter is off between pulses, the tag signal is detected by a receiver. A microcomputer checks the tag signal detected by the receiver to ensure it is at the right frequency, is time-synchronized to the transmitter, and that it is at the proper level and the correct repetition rate. If all these criteria are met, the alarm occurs.

### SUMMARY OF THE INVENTION

The inventor of the present invention is addressing the problems of glassware loss in the tavern type environment, and the problem of offsite alcohol consumptions by patrons taking glasses with alcohol outside of the tavern environment. The invention is the provision of an effective glassware tracking and/or control system. Specifically the invention is the application of existing inventory control systems to provide an effective glassware tracking and/or control system, namely an EAS tag integrated into glassware in a manner suitable for use in a tavern environment. Conventional tag recognition gates with associated alarms at the tavern exits or perimeter complete the system.

In one aspect of the invention the EAS tag is a passive RFID tag. Further the EAS tag is designed to accommodate conventional washing cycles of glassware (typically less than 90° C., generally less than 85° C.). In one aspect of the invention the EAS tag is a passive EM tag. In one aspect of the invention the EAS tag is a passive acousto-magnetic tag.

In one aspect of the invention the EAS tag is molded with the glassware to be encapsulated therein. In one aspect of the invention the EAS tag is inserted within a recess of the glassware to be integrated therein, and sealed with resin within the recess. In one aspect of the invention the EAS tag is attached to a base of the glassware to be integrated there with. In one aspect of the invention the EAS tag is secured around the stem of the glassware to be integrated therein, and sealed with resin within the recess.

In one aspect of the invention the EAS tag includes ornamental aspects visible to the customer.

In one aspect of the present invention a method of controlling offsite alcohol consumption and glassware loss in a tavern environment comprising the steps of providing an effective glassware tracking and/or control system for the tavern environment including passive EAS tag integrated into glassware in a manner suitable for use in a tavern environment and the provision of conventional tag recognition gates with associated alarms at the tavern exits complete the system.

These and other advantages of the present invention will be clarified in the detailed description of the preferred embodiments taken together with the attached figures wherein like reference numerals reference like elements throughout.

### BRIEF DESCRIPTION OF THE DRAWINGS

FIG. 1 is a sectional view of relevant portions of glassware with an integrated, encapsulated EAS tag of a tavern glassware tracking and/or control system in accordance with one aspect of the present invention;

FIG. 2 is a top plan view the glassware of FIG. 1;

FIG. 3 is a sectional view of relevant portions of glassware with an integrated EAS tag of a tavern glassware tracking and/or control system in accordance with another aspect of the present invention;

FIG. 4 is a sectional view of relevant portions of glassware with an integrated EAS tag of a tavern glassware tracking and/or control system in accordance with another aspect of the present invention;

FIG. 5 is a sectional view of relevant portions of glassware with an integrated EAS tag of a tavern glassware tracking and/or control system in accordance with another aspect of the present invention;

FIG. 6 is a side elevation view, partially in section, of relevant portions of glassware with an integrated, encapsulated EAS tag of a tavern glassware tracking and/or control system in accordance with another aspect of the present invention;

FIG. 7 is a side elevation view of glassware with an integrated EAS tag of a tavern glassware tracking and/or control system in accordance with another aspect of the present invention; and

FIG. 8 is a side elevation view of glassware with an integrated EAS tag of a tavern glassware tracking and/or control system in accordance with another aspect of the present invention.

### DETAILED DESCRIPTION OF THE INVENTION

It is noted that, as used in this specification and the appended claims, the singular forms “a,” “an,” and “the” include plural referents unless expressly and unequivocally limited to one referent. The various embodiments and examples of the present invention as presented herein are each understood to be non-limiting with respect to the scope of the invention.

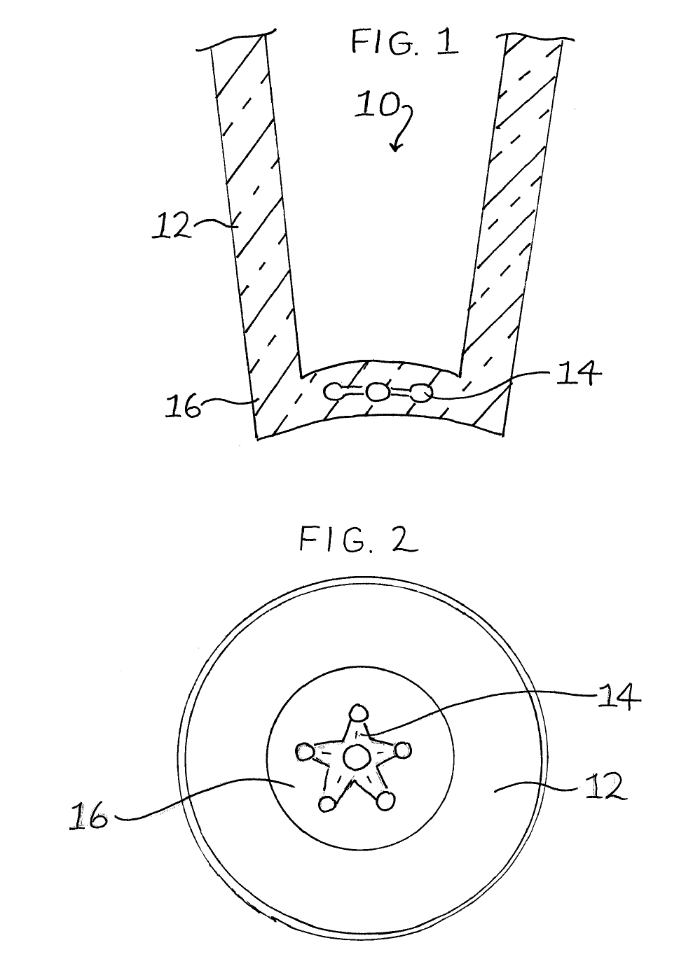

FIG. 1 is a sectional view of relevant portions of glassware 10 with sidewalls 12 and an integrated, passive EAS tag 14 encapsulated in the base 16. In this embodiment the tag 14 is formed in the base during the formation (e.g. molding) of the glassware 10. Conventional tag recognition gates (not shown) with associated alarms at the tavern exits (or perimeter) are used with the glassware 10. The glassware 10 and the conventional tag recognition gates with associated alarms form an effective glassware tracking and/or control system appropriate for use in a tavern environment.

Encapsulating the tag 14 within the base 16 provides several advantages. It allows the tag 14 to be protected from damage (e.g. water damage) or unintentional removal. The tag 14 may be a passive RFID tag that is designed to accommodate conventional washing cycles of glassware (typically less than 90° C., generally less than 85° C.). The tag 14 may be a passive EM tag, which will also accommodate conventional washing cycles. The tag 14 may be a passive acoustic-magnetic tag, which will also accommodate conventional washing cycles. In addition to repeated washing cycles, the tag 14 must accommodate (once) the manufacturing process environment for the glass 10 if it is integrated into the glass 10 at time of manufacture. Insert injection molding techniques may be used for encapsulation of the tag 14 in the base 16.

It may be helpful to encapsulate the tag 14 within a protective insulating cover, such as a ceramic cover, that will allow the tag 14 to undergo the manufacturing (if needed) and washing temperatures associated with the glass 10.

As the glass 10 is typically transparent, it is beneficial if the tag 14 includes an ornamental exterior, which may be in the form of a protective cover (e.g. a waterproof, insulating cover). For example the tag 14 may be in an ornamental shape, such as a star pattern as shown (which may be applicable for western themed restaurants). Specific restaurant monikers and logos may be provided on the exterior of the tag 14 without effecting the operation thereof. It can be expected that the tags 14, or covers therefore, will be personalized for each establishment as desired.

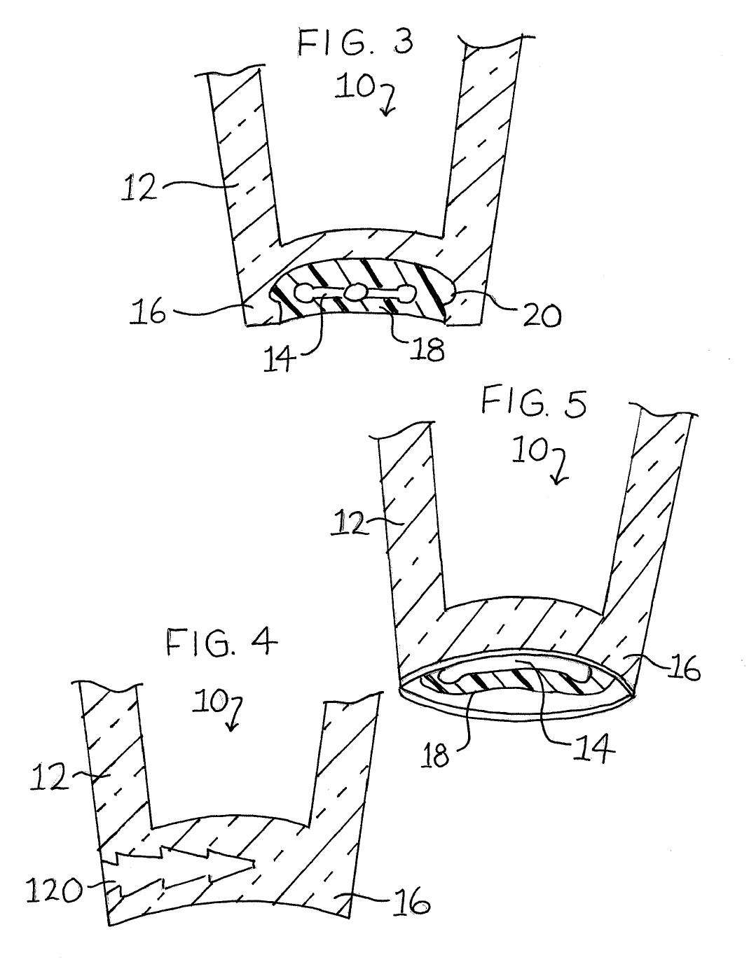

FIG. 3 is a sectional view of relevant portions of glassware 10 with sidewalls 12 and an integrated, passive EAS tag 14 encapsulated in the base 16. In this embodiment the tag 14 is formed in the base 16 after the formation (e.g. molding) of the glassware 10. Specifically, the tag 14 is encapsulated in resin 18 within a recess 20 in the base 16. As shown the recess 20 may be formed with a ridge or other overhang in which the resin 18 will lock the tag 14 in position after setting. Conventional tag recognition gates (not shown) with associated alarms at the tavern exits are used with the glassware 10 of FIG. 3. The glassware 10 and the conventional tag recognition gates with associated alarms form an effective glassware tracking and/or control system appropriate for use in a tavern environment as noted above. FIG. 3 is merely intended to illustrate a post glass manufacturing possibility for the integration of the tag 14.

FIG. 4 is a sectional view of relevant portions of glassware 10 with sidewalls 12 and an integrated, passive EAS tag 14 formed in the base after the formation (e.g. molding) of the glassware 10. Here the recess 20 is formed with one-way holding mechanisms that securely lock onto a similarly formed tag 14 that can be slid into the recess from the side wall 12.

FIG. 5 is a sectional view of relevant portions of glassware 10 with sidewalls 12 and an integrated, passive EAS tag 14 formed in the base after the formation (e.g. molding) of the glassware 10. Here the tag 14 is attached to a conventional beveled bottom recess and held by an overlaying adhesive (such as tape) or resin 18.

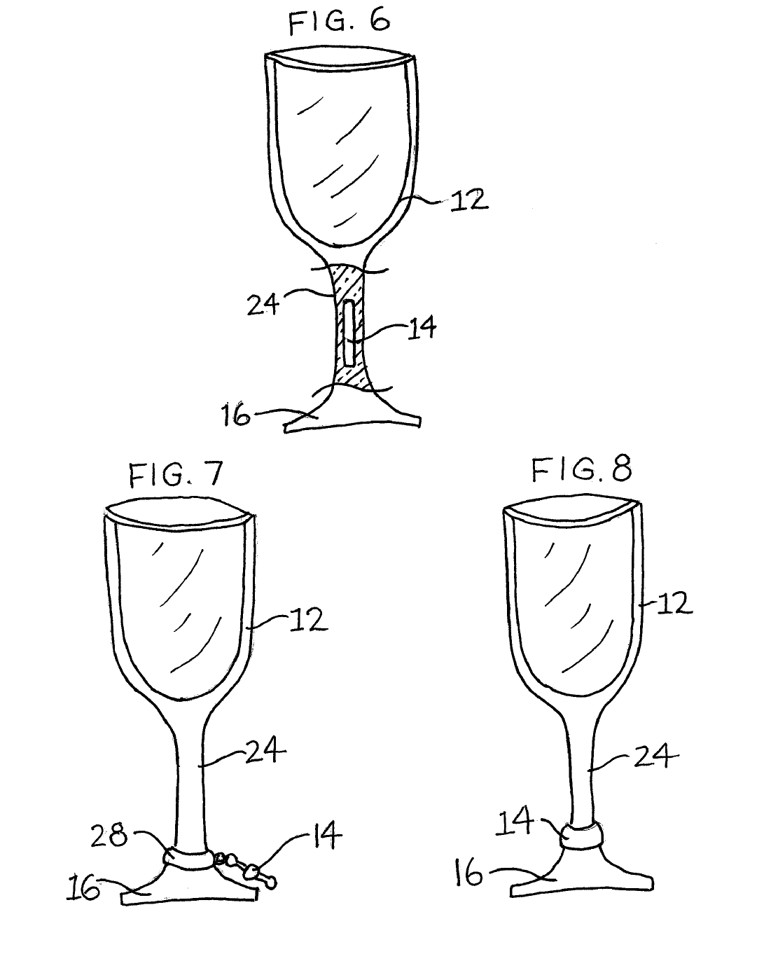

FIG. 6 is a side view, partially in section, of relevant portions of glassware 10 with sidewalls 12 and an integrated, encapsulated, passive EAS tag 14 formed in the stem 24 during the formation (e.g. molding) of the glassware 10. This embodiment is merely a different possible location for the tag 14. The stem 24 has certain limitations due to the narrowing of the glass material, however with a sufficiently small tag 14, any location within the glass 10 may be possible.

FIG. 7 is a side view of relevant portions of glassware 10 with sidewalls 12 and an integrated, passive EAS tag 14 coupled to the stem 24 following the formation (e.g. molding) of the glassware 10. In this embodiment the tag 14 is attached to a stem coupler 28 and the tag 14 may act as a “charm” or glass identifier, common in wine glass stemware.

FIG. 8 is a side view of relevant portions of glassware 10 with sidewalls 12 and an integrated, passive EAS tag 14 coupled to the stem 24 following the formation (e.g. molding) of the glassware 10. In this embodiment the tag 14 is formed as a stem coupler.

In operation the system using the glasses 10 operate to minimize loss by having alarms at the exits in conventional antenna. The antenna may be intentionally visible to provide visual reminders to customers to not take the glassware. Alternatively the exit antenna may be effectively hidden from customer views.

In addition to loss prevention the system of the present invention will minimizing off site drinking of alcohol by patrons, by preventing the patrons from leaving the establishment with the glassware. The presence and proper use of the system of the present invention will clearly indicate to local law enforcement that the establishment is doing all that it can to prevent off site drinking (e.g. drinking alcohol in the parking lot or the like). The method according to the present invention of controlling on site alcohol consumption through maintaining glassware on-site can be expanded to address alcohol that remains in the original alcohol container (e.g. beer bottles, beer cans, wine bottles, etc). The original alcohol containers are operationally different than tavern glassware, as these are pre-packaged, generally disposable containers

There are certain applications where the glassware itself creates concerns when taken outside of the designated tavern environment. For example, for establishments that are adjacent a swimming pool, the danger of broken glass within the pool area provides a different hazard that must be controlled and eliminated, if possible. The costs of shutting down a pool to adequately clean up broken glass far exceed the costs of replacing the glass itself. The present system and method of controlling glassware use is believed to be far more effective than only having signs identifying to patrons that there is “no glassware permitted in the pool area.”

Tavern Management

The apparatus and method of controlling glassware according to the present invention provides a significantly advantageous method and apparatus for improving tavern management. The system can provide even far greater management advantages through the inclusion of further scanners or gates at each point of sale machine (e.g. cash register) that can identify the tags associated with each individual glass. Many point of sale machines or registers now have the ability to associate a particular drink or combination of ingredients with a particular sale. In other words there are a number of present buttons associated with particular drinks and/or ingredients that the bartender can enter in ringing up a sale. With this type of point of sale machine coupled with a scanner and glass tag of the present invention the particular drinks can be associated per glass in a management system. In this manner the bartender can scan the glass through/over the gate associated with the cash register and the particular drink that is associated with that glass may be recorded. The point of sale machines are, or can be easily, associated with controllers for other systems, such as inventory control systems or the like. It is within the ability of one of ordinary skill in the art of electronic surveillance systems to provide the tag reading data, which is obtained from reading the tagged glasses at the point of sale machine, to the controllers of the point of sale machines in a manner sufficient to couple this glass data to the data entry from the point of sale machine. Further, it is believed to be within the skill of one of ordinary skill in the art in the inventory control/point of sale machine art to incorporate and use this information in the following management methods. This simple association provides a large number of management advantages.

One cause of customer dissatisfaction is a miscue on a drink order. A large number drink orders are simply refills, but this requires the bartender or waitress to inquire regarding what the patron is having, and it can be difficult due to the loud environments or a host of other tavern related interpersonal communication problems. The problem is compounded when the waitress needs to remember the order and again relay it to the bartender, repeating the chance for error. A patron will often seek refills for other members of his party and there can be unfamiliarity with the particular drinks by the patron that cause errors. With a specialty drink order the patron may not remember exactly what the drink was, making the refill dependent upon the memory of the bartender. The present system for tavern management eliminates these issues. Refills can be made simply by returning the original glass to the bartender and a simple scan can identify what the drink was exactly. Waitresses, patrons, bartenders need not ask what a particular drink was in order to obtain an accurate refill, the glasses merely need to be scanned, the previous drink sold in this glass will appear and the orders filled.

The system will include the ability to replace the old glass with new glasses for a refill if desired.

Providing a scanner at the dishwashing station will allow the system to prevent anything but refills from being placed into a glass until it has gone through the dishwashing system, as a further check on the management system.

The present management system greatly improves refill accuracy. Further, it improves billing on refills. Billing can be accomplished with a simple re-fill button. In addition to re-fill billing the system allows for easy party billing and billing of running tabs. Even in a crowded bar, the present system allows for a group of patrons to have their party's drinks rung up on a given tab or account even through multiple bartending stations. With the parties first order the tagged glasses, which are supplied to fill the first order, can be associated with a specific party in the billing system as well as with each drink associated glass as described above. Refills can be easily added to the tab as noted above, further if the patron in the specified party switches to a different drink type with a different glass the bartender merely swaps out the existing glass for a new one which is added to the parties list of tagged glasses.

The system allows for the patron group to control their group as they see fit. For example the patrons may establish a three drink maximum per party member (i.e. per glass including replacement glasses) which the system can easily track and the bartender can be notified by the system when a glass is returned for a drink in excess of that amount. As another representative example a holiday party for a small company could have set a dollar amount on drinks with the system cutting off the tab after it exceeds that amount.

A further billing advantages of the present system is associating discounts with a given party or patron. The ability to give a discount can then be easily limited to a head bartender or manager, with subsequent discounts associated with the original glasses or replacements therefore that can be rung up by any bartender.

A further control system feature of the present system is it can track the number of drinks per glass per hour so that a there is a further system can be in place to prevent over serving certain customers. The system can be set, for example, to no more than 3 drinks per hour and 10 drinks per night. The limits are easily set by the management and these are merely representative for illustrative purposes.

The present system will allow managers know what drinks are “out on the floor” and which ones have been sold and when such drinks are sold. This can be used to better manage the establishment and to manage alcohol re-ordering.

Many point of sale machines further require bartenders to enter an identification code for each sale. The present system would allow such systems to track which bartenders sold which specific drinks. Further, if bartenders are provided with an identification tag that can be read by the scanner they can more easily enter their ID into the system. The ID can be in the form of an employee badge, a bracelet, necklace or ring worn by the bartender. In this manner as the bartender scans the glass the bartender ID will also be scanned and associated automatically with the associated glass. In this manner the system becomes a tool for simplifying the bartender's job and is more readily embraced by the bartenders, rather than a bartender oversight tool that is resented by the bartenders (and thus reluctant to be employed by establishments).

The system can be used to evaluate bartenders and sales at locations within the establishment for better tavern management. The system can be used as a further check on inventory control. The information that can be obtained effectively relates any parameter derived from glassware flow throughout the establishment and associated alcohol flow. There can be a number of other advantages associated with this management tool.

The tavern management techniques above flow from the identification capabilities of the electronic surveillance tags. In other words the system can uniquely identify each glass. Many of the unique tavern management techniques of this system can be obtained using any scan-able glass identifier, such as a simple bar code. The loss prevention features of the present invention require the ability to detect the presence of a tag in a designated field (e.g. within the gate) which is available in electronic surveillance tags but not necessarily in all scan-able tags.

A further advantageous addition to the present invention is the incorporation of a warning indicator in the glass, such as an LED light or an audible buzzer or both that will go off as the patron is moving an unauthorized glass passed or even near an exit gate. It may be understood that the system can accommodate the turning off of the tags if the patron is allowed to take the glass, i.e. where they have purchased the glass. This authorized taking of the glass is somewhat common for electronic surveillance tag systems (it is how customers leave the stores with purchased merchandise).

The present invention has been described with reference to specific details of particular embodiments thereof. It is not intended that such details be regarded as limitations upon the scope of the invention except insofar as and to the extent that they are included in the accompanying claims.

We claim:

1. Integrated glassware control system for a tavern environment comprising:
(a) a plurality of glassware drinking vessels;
(b) an electronic article surveillance tag coupled to each glassware drinking vessel; and
(c) at least one tag recognition gate at one of a tavern exit or point of sale machine, each tavern exit gate having an associated alarm that is activated upon detection of an unauthorized tag, and each point of sale tag recognition gate configured to associate the glass with a particular sale.

2. The integrated glassware control system for a tavern environment according to claim 1 wherein each electronic article surveillance tag is a RFID tag.

3. The integrated glassware control system for a tavern environment according to claim 1 wherein each electronic article surveillance tag is designed to accommodate conventional washing cycles of glassware.

4. The integrated glassware control system for a tavern environment according to claim 1 further including a tag recognition gate associated with a point of sale machine of the establishment.

5. The integrated glassware control system for a tavern environment according to claim 1 wherein each electronic article surveillance tag is molded with the glassware to be encapsulated therein.

6. The integrated glassware control system for a tavern environment according to claim 1 wherein each electronic article surveillance tag is positioned within a recess of the glassware to be integrated therein.

7. The integrated glassware control system for a tavern environment according to claim 6 wherein each electronic article surveillance tag is sealed with resin within the recess.

8. The integrated glassware control system for a tavern environment according to claim 1 wherein each electronic article surveillance tag is attached to a base of the glassware to be integrated there with.

9. The integrated glassware control system for a tavern environment according to claim 1 wherein each electronic article surveillance tag is includes ornamental aspects visible to the customer.

10. A method of controlling offsite alcohol consumption and glassware loss in a tavern environment comprising the steps of providing a glassware tracking and/or control system for the tavern environment including electronic article surveillance tags integrated into glassware in a manner suitable for use in a tavern environment and the provision of tag recognition gates with associated alarms provided at least one of the tavern exits.

11. The method of controlling offsite alcohol consumption and glassware loss in a tavern environment according to claim 10 wherein each electronic article surveillance tag is a RFID tag.

12. The method of controlling offsite alcohol consumption and glassware loss in a tavern environment according to claim 10 wherein each electronic article surveillance tag is designed to accommodate conventional washing cycles of glassware and further comprising the step of washing the glassware and tag after each customer use.

13. The method of controlling offsite alcohol consumption and glassware loss in a tavern environment according to claim 10 wherein each electronic article surveillance tag is an acousto-magnetic tag.

14. The method of controlling offsite alcohol consumption and glassware loss in a tavern environment according to claim 10 further including the step of molding each electronic article surveillance tag with the glassware to be encapsulated therein.

15. The method of controlling offsite alcohol consumption and glassware loss in a tavern environment according to claim 10 further including the step of inserting each electronic article surveillance tag within a recess of the glassware to be integrated therein.

16. The method of controlling offsite alcohol consumption and glassware loss in a tavern environment according to claim 15 further including the step of sealing each electronic article surveillance tag with resin within the recess.

17. The method of controlling offsite alcohol consumption and glassware loss in a tavern environment according to claim 10 further including the step of attaching each electronic article surveillance tag to a base of the glassware to be integrated there with.

18. The method of controlling offsite alcohol consumption and glassware loss in a tavern environment according to claim 10 wherein each electronic article surveillance tag is includes ornamental aspects visible to the customer.

19. A method of controlling the movement of customers with alcoholic beverages comprising the steps of serving the alcoholic beverages within glass containers the glass containers including electronic article surveillance tags integrated into the glassware and providing tag recognition gates at least one of a tavern exit or point of sale machine, each tavern exit gate having an associated alarm that is activated upon detection of an unauthorized tag, and each point of sale tag recognition gate configured to associate the glass with a particular sale.

20. The method of controlling offsite the movement of customers with alcoholic beverages according to claim 19 wherein each electronic article surveillance tag is includes ornamental aspects visible to the customer.
